(19) United States
(12) Patent Application Publication
(10) Pub. No.: US 2025/0244595 A1
(43) Pub. Date: Jul. 31, 2025

(54) DIMMING DEVICE, LASER MACHINING DEVICE, AND LASER BEAM MEASUREMENT DEVICE

(71) Applicant: Tamron Co., Ltd., Saitama (JP)

(72) Inventors: Kazunori KOMORI, Saitama (JP); Erika KATAYAMA, Saitama (JP)

(73) Assignee: Tamron Co., Ltd., Saitama (JP)

(21) Appl. No.: 18/936,428

(22) Filed: Nov. 4, 2024

(30) Foreign Application Priority Data
Jan. 30, 2024 (JP) 2024-011447

(51) Int. Cl. G02B 27/10; B23K 26/064; G01J 1/42; G02B 27/14

(52) U.S. Cl. CPC G02B 27/108; B23K 26/064; G01J 1/4257; G02B 27/142; G01J 2001/4261

(57) ABSTRACT

To achieve the object, provided is a dimming device including a beam splitter that has an optical thin film of 10 or more layers formed close to a surface on which the laser beam is incident, and that, when any orthogonal coordinate axes whose origin in a plane perpendicular to an optical axis of the laser beam irradiation optical unit is on the optical axis are defined as an X axis and a Y axis, is disposed so as to be inclined at an angle α of 30° or more and 60° or less with respect to the optical axis with the X axis as a rotation axis.

### CROSS-REFERENCE TO RELATED APPLICATIONS

This application is based on and claims the benefit of priority from Japanese Patent Application No. 2024-011447, filed on Jan. 30, 2024, the entire contents of which are incorporated herein by reference.

### BACKGROUND OF THE INVENTION

### Technical Field

The present invention relates to a dimming device that dims a laser beam radiated from a laser beam irradiation optical unit that irradiates an object to be machining processed with the laser beam collected and condensed, a spot being formed at the object to be machining processed, to perform laser machining, a laser machining device including the dimming device, and a laser beam measurement device including the dimming device.

### Related Art

In recent years, laser beams have been widely used for processing various products. The laser beam is focused at one point and radiated to a workpiece, thereby rapidly increasing a surface temperature of the workpiece and melting or evaporating an irradiated surface of the workpiece. A laser machining device using such a laser beam is a device that performs machining such as cutting, drilling, or welding on the workpiece by doing so. Since the laser beam is collected and condensed at one point, precise and fine processing can be performed at a pinpoint. In addition, by using a higher-energy laser beam, a machining time can be shortened, and it is also possible to perform machining on a high-hardness workpiece that is difficult to process with a blade.

Here, the laser machining device includes a laser beam irradiation optical unit. A conventionally employed laser beam irradiation optical unit has a function of collecting and condensing a laser beam at one point of a spot, or radiating a laser beam having a circular image shape at the spot and a Gaussian or top-hat energy intensity distribution. However, in laser machining employing such a conventional image shape at a spot, there has been a problem that a workpiece melted by a laser beam remains on a cut surface or a hole portion at the time of cutting, welding, or drilling the workpiece, causing a deterioration in processing quality. Therefore, in recent years, it has been proposed that laser machining in which an image shape of a laser beam at the spot is annular so that a molten workpiece is appropriately ejected and does not remain on a cut surface or in a hole portion.

Before laser machining is performed, a laser beam measurement device is used to confirm that an image shape of a laser beam and an energy intensity distribution of the image shape at the spot have desired specifications. As a laser beam dimming means in this laser beam measurement device, the following method has been known: a method in which a laser beam is dimmed through a filter, and observed by an image sensor such as a CCD or CMOS, a method in which a transmitted light intensity is measured while a partial portion of the laser beam is shielded with a pinhole, a slit, or a knife edge, and obtained by a calculation from a correlation of the transmitted light intensity with a light shielding position, a method in which an intensity distribution is measured by secondarily scanning a rod with a small mirror at a tip or a light guide rod with a small hole at a tip in a laser beam, a method in which a plate for scattering the laser beam is irradiated with a laser beam, and an image of scattered light is captured by a camera from behind, or the like.

However, in the above-described method, there is problem that the filter is deformed by heat of the laser beam, an image shape of the laser beam is impaired in the pinhole, the slit, or the knife edge, it is difficult to measure a minute image shape with the small mirror, or blurring occurs in the image when the scattered light is used. Therefore, there has also been proposed a method of measuring an image shape of a laser beam and an energy intensity distribution in the image shape by dividing the laser beam into transmitted light and reflected light using a beam splitter to dim the beam and observing the transmitted light or the reflected light.

Here, as a structure for controlling the reflectance and transmittance of the optical element, a structure in which an optical thin film in which a high refractive index layer and a low refractive index layer are alternately stacked is provided on the surface of the optical element is known. JP 2009-282295 A discloses a reflection reducing film having a multilayer structure including a reflection reducing layer including first to eighth layers on a substrate. For example, in Example 1-1, in the wavelength band of 400 nm to 900 nm, the reflectance for perpendicular incident light (regular incident light) is approximately 0.3% (that is, the transmittance is 99.7%), and the reflectance for 450 incident light is approximately 1% (that is, the transmittance is 99%).

As described above, in a normal imaging device or the like, it is an object to reduce reflectance by using an optical thin film for an optical element using transmitted light and to realize high transmittance. At this time, if the transmittance at an incident angle of a light beam on the optical element of 45° is 99.0% and the transmittance at an incident angle of a light beam on the optical element of 50° is 99.5%, the transmittances are relatively different by 1.005 times (or 0.995 times). In this case, the difference in transmittance at the different incident angles is very small, and the image quality of the image captured using the optical element is not greatly affected. That is, it is only required to achieve a high transmittance of 99% or more in the wavelength band to be used, and even when the difference in transmittance due to the difference in the incident angle of the light beam is, for example, about 0.5%, there is no particular problem. This applies even in a case where an optical element using reflected light is used.

On the other hand, when the laser beam is dimmed using the beam splitter, the intensity of the incident laser beam is as strong as, for example, several hundred watts or more, and thus it is necessary to set the transmittance or the reflectance to, for example, several percent or less so as not to damage the observation device. Here, the laser beam with which the object to be machining processed is irradiated with is generally collected light. In this case, the incident angle of the laser beam when the laser beam is incident on the beam splitter has different angle values depending on the incident position on the beam splitter. When a laser beam dimming device that uses transmitted light for observation is provided, a transmittance at an incident angle of 45° to a beam splitter is 1% and a transmittance at an incident angle of 50° to the beam splitter is 1.5%, the transmittances are relatively different by 1.5 times (or 0.667 times). In this case, the difference in transmittance at the different incident angles is large, and the image shape of the laser beam and the energy intensity distribution in the image shape cannot be accurately measured. This applies even in a case where reflected light is used for observation.

That is, the inventor of the present invention has found that, in a case where a laser beam is dimmed using a beam splitter, unlike an optical element used in a normal imaging device, a transmittance of the beam splitter in a case where transmitted light is used for observation or a reflectance of the beam splitter in a case where reflected light is used for observation requires a very small value such as 1% or less, for example, so that only a difference of 0.5% in transmittance or reflectance at different incident angles causes a very large problem as described above.

Furthermore the inventor according to the present invention has found that, in addition to the problem of the incident angle dependency of the transmittance or the reflectance described above, in a case where an annular image shape or an energy intensity distribution at the spot is to be measured, when deformation (for example, a circle is changed to elliptical) occurs in an image shape of a laser beam at a spot such as transmitted light or reflected light via a beam splitter, an adverse effect on a measurement result more remarkably appears.

Here, the reflection reducing film of JP 2009-282295 A is only required to achieve a high transmittance of, for example, 99% or more in a wavelength band to be used, and even when the difference in transmittance due to the difference in the incident angle of the light beam is, for example, about 0.5%, there is no particular problem. However, in the case of dimming the laser beam using the beam splitter employing this optical thin film, dimming with a reflectance of 1% or less is possible using reflected light, but a difference in reflectance due to a difference in the incident angle of the light beam is about 0.5%, so that the image shape of the laser beam and the energy intensity distribution in the image shape cannot be accurately measured.

As described above, in the optical thin film used in a general imaging device represented by the reflection reducing film of JP 2009-282295 A, for example, transmitted light at a transmittance of 1%, reflected light at a reflectance of 1%, or a ratio of a value of an incident angle in a range of 40° to 50° to a value of 45° is not disclosed, and the necessity of the performance is not discussed. It is not disclosed that the values of transmittance (or reflectance) at different incident angles are matched with high accuracy. For this reason, there is a problem that even when the conventional optical thin film is used for the beam splitter, the image shape and the intensity distribution of the laser beam cannot be correctly measured.

The present invention has been made in view of such circumstances. An object of the present invention is to provide a dimming device that dims a laser beam using a beam splitter to an extent that a device that acquires image data such as an image sensor or a camera is not destroyed even when energy intensity of an incident laser beam is high, and dims a laser beam capable of accurately measuring an image shape and an energy intensity distribution of the laser beam at a spot even when the incident laser beam is collected light, the laser beam being radiated from a laser beam irradiation optical unit, and a laser beam measurement device including the dimming device.

### SUMMARY OF THE INVENTION

In order to solve the above-described problems, as a result of intensive research, a dimming device to be described below and a laser beam measurement device including the dimming device have been conceived.

A dimming device according to the present invention employs a dimming device that dims a laser beam radiated from a laser beam irradiation optical unit that irradiates an object to be machining processed with the laser beam collected and condensed, a spot being formed at the object to be machining processed, to perform laser machining, the dimming device including a beam splitter that has an optical thin film of 10 or more layers formed close to a surface on which the laser beam is incident, and that, when any orthogonal coordinate axes whose origin in a plane perpendicular to an optical axis of the laser beam irradiation optical unit is on the optical axis are defined as an X axis and a Y axis, is disposed so as to be inclined at an angle α of 30° or more and 60° or less with respect to the optical axis with the X axis as a rotation axis.

A laser machining device according to the present invention employs a laser machining device including a laser beam irradiation optical unit configured to irradiate an object to be machining processed with a laser beam collected and condensed, a spot being formed at the object to be machining processed, to perform laser machining, and a dimming device configured to dim the laser beam radiated from the laser beam irradiation optical unit by using a beam splitter that has an optical thin film of 10 or more layers formed close to a surface on which the laser beam is incident, and that when any orthogonal coordinate axes whose origin in a plane perpendicular to an optical axis of the laser beam irradiation optical unit is on the optical axis are defined as an X axis and a Y axis, is disposed so as to be inclined at an angle α of 30° or more and 60° or less with respect to the optical axis with the X axis as a rotation axis.

A laser beam measurement device according to the present invention employs a laser beam measurement device including the above-described dimming device and an observation device that observes a laser beam dimmed by the dimming device.

The dimming device that dims the laser beam radiated from the laser beam irradiation optical unit according to the present invention can dim a laser beam using a beam splitter to an extent that a device that acquires image data such as an image sensor or a camera is not destroyed even when energy intensity of an incident laser beam is high, and accurately measure an image shape and an energy intensity distribution of the laser beam at a spot even when the incident laser beam is collected light.

### BRIEF DESCRIPTION OF THE DRAWINGS

FIG. 1 is a schematic diagram of a dimming device according to the first embodiment;

FIGS. 2A and 2B is an enlarged view of a beam splitter;

FIG. 3 is a schematic view of a dimming device according to another aspect of the first embodiment;

FIG. 4 is a schematic view of a dimming device of the second embodiment;

FIGS. 5A and 5B is an enlarged view of a beam splitter;

FIG. 6 is a schematic view of a dimming device according to another aspect of the second embodiment;

FIG. 7 is a schematic view of a laser machining device;

FIG. 8 is a graph of transmittance characteristics of Example 1; and

FIG. 9 is a graph of reflectance characteristics of Example 2.

### DESCRIPTION OF THE EMBODIMENTS

Hereinafter, embodiments of a dimming device that dims a laser beam radiated from a laser beam irradiation optical unit according to the present invention and a laser beam measurement device including the dimming device will be described. Note that what will be described below merely shows an aspect, and the present invention is not construed as being limited to the following description.

### 1. Embodiment of Dimming Device that Dims Laser Beam Radiated from Laser Beam Irradiation Optical Unit

A dimming device according to the present invention is a dimming device that dims a laser beam radiated from a laser beam irradiation optical unit that irradiates an object to be machining processed with the laser beam collected and condensed, a spot being formed at the object to be machining processed, to perform laser machining. In a case where the image shape of the laser beam and the energy intensity distribution of the laser beam at the spot are measured using the observation device, the dimming device is used to dim the laser beam so as not to damage the observation device by the high energy of the laser beam and to cause the laser beam to be incident on the observation device. That is, the dimming device in the present invention is an optical system that reduces the energy intensity of the laser beam incident on the dimming device to output the laser beam from the dimming device.

The laser beam irradiation optical unit is an optical system necessary for laser machining, and is an optical system that forms an image shape of the laser beam and an energy intensity distribution of the laser beam at the spot as desired and radiates the laser beam so as to be collected and condensed at the spot. Here, the dimming device according to the present invention is attached between the laser beam irradiation optical unit and the spot and dims the laser beam radiated from the laser beam irradiation optical unit in order to measure an image shape of the laser beam and an energy intensity distribution of the laser beam at the spot. Then, after the image shape of the laser beam and the energy intensity distribution of the laser beam at the spot are measured, the image shape of the laser beam and the energy intensity distribution of the laser beam at the spot can be adjusted and measured again when necessary, and then the dimming device can be detached from the laser beam irradiation optical unit. Thereafter, an object to be machining processed can be installed at the position of the spot to perform laser machining. In addition, laser machining is performed in a state where the dimming device is attached to the laser beam irradiation optical unit, and the image shape and the energy intensity distribution of the laser beam branched from the dimming device can be observed during the laser machining.

Note that the laser beam irradiation optical unit according to the present invention may include any optical system as long as the laser machining can be performed. For example, the laser beam irradiation optical unit may include a galvano optical system including a galvano mirror.

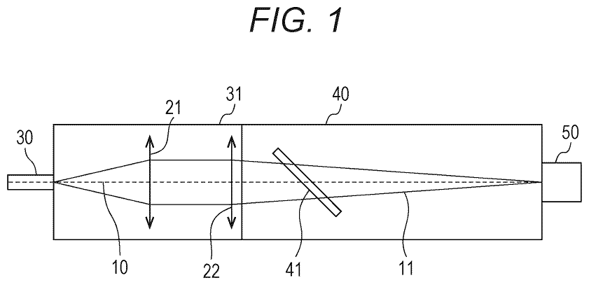

FIG. 1 illustrates an arrangement configuration of the dimming device and a substantial radiation trajectory of a laser beam of the first embodiment of the dimming device according to the present invention. In the dimming device according to the first embodiment, an optical fiber 30 that guides and emits a laser beam output from a laser oscillator (not illustrated), a collimator lens 21 that collimates the laser beam output in a diffused manner from an output end of the optical fiber 30, a condenser lens 22 that collects and condenses the laser beam collimated by the collimator lens 21 at a spot on a surface of an object to be machining processed, a dimming device 40 that dims the laser beam collected and condensed at a spot by the condenser lens 22, and an observation device 50 that observes observation light for checking an image shape and an intensity distribution of the laser beam at the spot are disposed in order from the laser oscillator side along an optical axis 10 of a radiation trajectory 11 of a laser beam irradiation optical unit 31. The position of the optical center of the collimator lens 21 and the position of the optical center of the condenser lens 22 are disposed to coincide with the optical axis 10 in the laser beam irradiation optical unit 31. Then, the laser beam converges on a spot on the trajectory indicated by the radiation trajectory 11 and forms an image.

As a laser beam incident on the laser beam irradiation optical unit 31 from the laser oscillator via the optical fiber 30, any laser beam can be used as long as the laser beam can be used for laser machining. Specifically, a near-infrared laser beam having an oscillation wavelength of about 920 nm or more to 1090 nm or less, which is represented by a YAG laser (wavelength of 1064 nm), a fiber laser (wavelength of 1070 nm), a disk laser (wavelength of 1030 nm), and a semiconductor laser (wavelength of 935 nm, 940 nm, 980 nm, 940 to 980 nm, or 940 to 1025 nm), is preferable. The laser beam may be a laser beam in a blue, green, or ultraviolet region as long as the laser beam can be used for laser machining. In addition, the energy distribution of the laser beam incident on the laser beam irradiation optical unit 31 on a plane perpendicular to the optical axis 10 may be a Gaussian shape in which energy in a center portion (optical axis portion) is strong or may be uniform.

In FIG. 1, the collimator lens 21 and the condenser lens 22 are installed in the laser beam irradiation optical unit 31 in such a manner that their respective optical centers coincide with the optical axis 10. That is, an optical system necessary for laser machining is disposed in the laser beam irradiation optical unit 31. The dimming device 40 is connected to the laser beam irradiation optical unit 31, and the observation device 50 is connected to the dimming device 40. At this time, the dimming device 40 may be covered with a lens barrel or the like so that a laser beam does not leak from the dimming device 40. Furthermore, the dimming device 40 may be detachable from the laser beam irradiation optical unit 31. By connecting the detachable dimming device 40, to which the observation device 50 can be connected, to the laser beam irradiation optical unit 31 constituting the optical axis 10 of the laser beam radiation trajectory 11, an image shape of the laser beam and an energy intensity distribution of the laser beam can be measured at the spot. Then, after a measurement is performed by the observation device 50 and the image shape and the intensity distribution of the laser beam at the spot are adjusted to be desirable, the dimming device 40 and the observation device 50 are removed, and a surface of an object to be machining processed is located at the position where an image plane of the observation device 50 was located, so that laser machining can be performed with high accuracy.

Here, the image shape of the laser beam at the spot may be any image shape as long as the object to be machining processed can be processed with the laser beam. For example, at least one of the collimator lens 21 and the condenser lens 22 of the laser beam irradiation optical unit 31 can have a function of converting the image shape of the laser beam at the spot into an annular shape including at least an annular peripheral region (hereinafter referred to as an annular shape conversion function in the present specification). When the shape of the energy distribution at the spot is an annular shape including at least an annular peripheral region, the laser beam energy is uniformly irradiated in any direction with respect to the center region of the spot on the surface of the object to be machining processed. This allows zinc gas to be released during lap welding of molten zinc steel sheets, resulting in clean welding.

Furthermore, the shape of the spot based on the annular shape conversion function is not particularly limited, and the shape of the spot may include, for example, an annular shape and a point shape at a center portion of the annular shape (a Gaussian shape in the point portion), or may be a top-hat shape or the like. At this time, it is preferable that the energy intensity of the point-like spot in the center portion of the annular shape is higher than the energy intensity of the annular portion of the annular shape. This is because, in aluminum or the like having a high light reflectance, the metal can be melted at the annular portion having a low energy intensity to lower the reflectance, and an object to be machining processed can be melted deeply at the central portion having a high energy intensity, making laser machining easier.

In order to form the image shape of the spot described above, it is preferable that at least one optically effective surface of an optical element having an annular shape conversion function is any of a diffractive lens, an axicon lens, or an aspherical lens. This is because the spot shape of the laser beam can be an annular shape, or can include an annular shape and a point shape in the center portion of the annular shape.

Note that the laser beam irradiation optical unit 31 does not necessarily have an annular shape conversion function, and a laser beam in which the image shape of a laser beam radiated from the optical fiber 30 is an annular shape including at least an annular peripheral region may be used.

In addition, the laser beam irradiation optical unit 31 may include a laser beam direction adjustment mechanism including a connector unit to which the optical fiber 30 is connected and a connector receiving portion that fixes the connector unit to the optical axis 10. The laser beam direction adjustment mechanism adjusts the incidence direction of the laser beam on the laser beam irradiation optical unit 31 by turning at least one of the connector unit and the connector receiving portion in an arc shape with a center portion of a core of the optical fiber 30 at the laser beam output end as a center point. The laser beam output from the laser oscillator is guided to a laser machining head of a laser machining device using the optical fiber 30, and the emission direction of the laser beam output from the output end of the optical fiber 30 has a certain range of inclination in with respect to the optical axis 10. Specifically, for example, in a CW fiber laser manufactured by Raycus Fiber, an angle of an optical axis of a laser beam output from an output end of an optical fiber with respect to a reference optical axis determined by a structure of the output end of the optical fiber and a structure of a connector is 30 mrad (milliradian) or less. The laser beam direction adjustment mechanism can be used in a case where the emission direction of the laser beam output from the output end of the optical fiber 30 has a certain range of inclination in with respect to the optical axis 10 to adjust the incidence direction of the laser beam to the laser beam irradiation optical unit 31.

Note that the laser beam irradiation optical unit 31 has a configuration in which the collimator lens 21 and the condenser lens 22 are disposed therein, but may have any configuration as long as laser machining can be performed, and for example, only the condenser lens 22 may be disposed therein.

### First Embodiment of Dimming Device

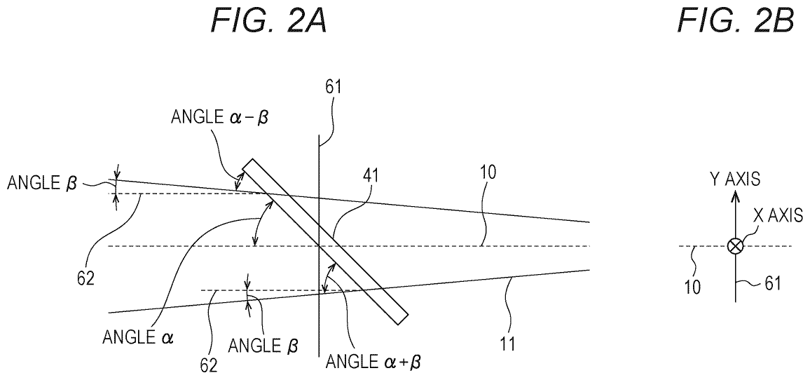

A first embodiment of a dimming device according to the present invention is a configuration of the dimming device 40 illustrated in FIG. 1, and includes a plate-type beam splitter 41 closer to the spot (the observation device 50) than the laser beam irradiation optical unit 31 and a cylindrical light guide unit that holds the beam splitter 41 and has an opening close to at least the laser beam irradiation optical unit 31. The beam splitter 41 has an optical thin film of 10 or more layers formed close to a surface on which the laser beam is incident. When any orthogonal coordinate axes whose origin in a plane perpendicular to the optical axis 10 is on the optical axis 10 are defined as an X axis and a Y axis, the beam splitter 41 is disposed so as to be inclined at an angle α in a range of 30° or more and 60° or less with respect to the optical axis 10 with the X axis as a rotation axis. Note that as illustrated in FIG. 2B, the X axis is a straight line, on the plane, perpendicular to the optical axis 10 described above, perpendicularly penetrating the plane when the figure of FIG. 1 is taken as the plane with the optical axis 10 as an origin, and the Y axis is a straight line, on the plane, perpendicular to the optical axis 10 described above, and perpendicular to the X-axis on the plane when the figure of FIG. 1 is taken as the plane with the optical axis 10 as an origin. The directionsof the arrows of the X axis and the Y axis may be opposite to the directions illustrated in FIG. 2B. In the present invention, the X axis and the Y axis are defined in the same manner as described above in the other drawings. The beam splitter 41 may be disposed in such a manner that the center position of the beam splitter 41 coincides with the optical axis 10, but may be disposed in such a manner that at least the laser beam radiation trajectory 11 is within the optically effective surface of the beam splitter 41. Although not illustrated in FIG. 1, the cylindrical light guide unit has a structure indicated by a frame line of the dimming device 40.

The beam splitter 41 has a function of splitting a laser beam collected and condensed at the spot by the condenser lens 22 into transmitted light and reflected light. In FIG. 1, the laser beam radiation trajectory 11 indicates a trajectory of a laser beam incident on the beam splitter 41 and a trajectory of transmitted light of the beam splitter 41, and reflected light of the beam splitter 41 is not illustrated. Unnecessary reflected light reflected by the beam splitter 41 may be radiated to a copper plate or the like processed to have a black surface so as to easily absorb the laser beam for absorptive radiation.

In FIG. 1, as indicated by the radiation trajectory 11, since a laser beam is incident on the beam splitter 41 via the condenser lens 22, the incident angle of the laser beam on the beam splitter 41 continuously changes in the Y axis direction described above. FIG. 2A illustrates an enlarged view of the beam splitter 41. The incident angle of the laser beam on the beam splitter 41 at the position of the optical axis 10 is an angle α. Here, the incident angle of the laser beam at the position of the upper end or the lower end of the radiation trajectory 11 with respect to the virtual line 62 parallel to the optical axis 10 is defined as an angle β. At this time, the incident angle of the laser beam on the beam splitter 41 at the position of the upper end of the radiation trajectory 11 is represented by α−β. Similarly, the incident angle of the laser beam on the beam splitter 41 at the position of the lower end of the radiation trajectory 11 is represented by α+β. That is, the incident angle of the laser beam on the beam splitter 41 changes in a range of α−β or more and α+β or less according to the incident position of the laser beam on the beam splitter 41. Here, the value of the angle β is not particularly limited, but the angle β is 5° or less in consideration of the optical design of the laser beam irradiation optical unit. Therefore, the incident angle of the laser beam on the beam splitter 41 is in the range of α−5° or more and α+5° or less.

Here, it is preferable that the transmittance of the beam splitter 41 when the incident angle of the laser beam on the beam splitter 41 is an angle α is 2.0% or less. This is because even when the transmitted light of the beam splitter 41 is incident on the observation device 50 in order to measure the energy intensity distribution and the image shape of the laser beam, the observation device 50 can perform measurement without causing destruction or deterioration. In the specification of the present invention, the beam splitter 41 is referred to as a transmission type. Note that, since a necessary function of the beam splitter 41 is dimming of an incident laser beam and is not light shielding, the transmittance of the beam splitter 41 at the angle α is preferably 0.001% or more.

The transmission type beam splitter 41 preferably satisfies following Conditional Expression (1). This is because, by satisfying the Conditional Expression, even when the incident angle of the laser beam on the beam splitter 41 changes in the range of α−5° or more and α+5° or less, the variation in the transmittance can be reduced, and the observation device 50 can measure the energy intensity distribution at the spot by the transmitted light of the beam splitter 41 with high accuracy.

$$0 \leq ( T max - T min ) / Tave \leq 0.05 \qquad ( 1 )$$

where
Tmax is a maximum value of a transmittance of the beam splitter 41 when an incident angle of the laser beam on the transmission type beam splitter 41 is in a range of α−5° or more and α+5° or less,
Tmin is a minimum value of a transmittance of the beam splitter 41 when an incident angle of the laser beam on the transmission type beam splitter 41 is in a range of α−5° or more and α+5° or less, and
Tave is an average value of transmittances of the beam splitter 41 when an incident angle of the laser beam on the transmission type beam splitter 41 is in a range of α−5° or more and α+5° or less.

Here, as illustrated in FIGS. 2A and 2B, the beam splitter 41 is disposed so as to be inclined at an angle α in a range of 30° or more and 60° or less with respect to the optical axis 10 with the X axis as a rotation axis. When the plate-type beam splitter is disposed to be inclined with respect to the plane 61 perpendicular to the optical axis 10 in this manner, in a case where collimated light is incident on the beam splitter, the trajectory of light emitted from the beam splitter is shifted with respect to the incident light due to refraction. In a case where collected light is incident on the beam splitter, in addition to the shift of the trajectory, astigmatism occurs in which the emitted light is collected and condensed at different focal distances in the Y axis direction although the emitted light is collected and condensed at the same focal distance in the X axis direction. That is, an image of the laser beam transmitted through the beam splitter 41 with the X axis as rotation axis is distorted in the Y axis direction due to astigmatism.

In this case, since the amount of distortion of the image in the Y axis direction due to astigmatism can be grasped in advance by performing optical simulation of the optical system, for example, the output data of the observation device 50 can be corrected by performing numerical calculation using an arithmetic device based on predicted distortion amount data to observe a correct image shape. In addition, since the beam splitter 41 is disposed to be inclined at the angle α with the X axis as a rotation axis, the incident angle of the laser beam on the optical surface of the beam splitter 41 does not change in the X-axis direction. That is, the image shape and the energy intensity distribution of the laser beam at the spot can be measured by using the observation data in the X axis direction.

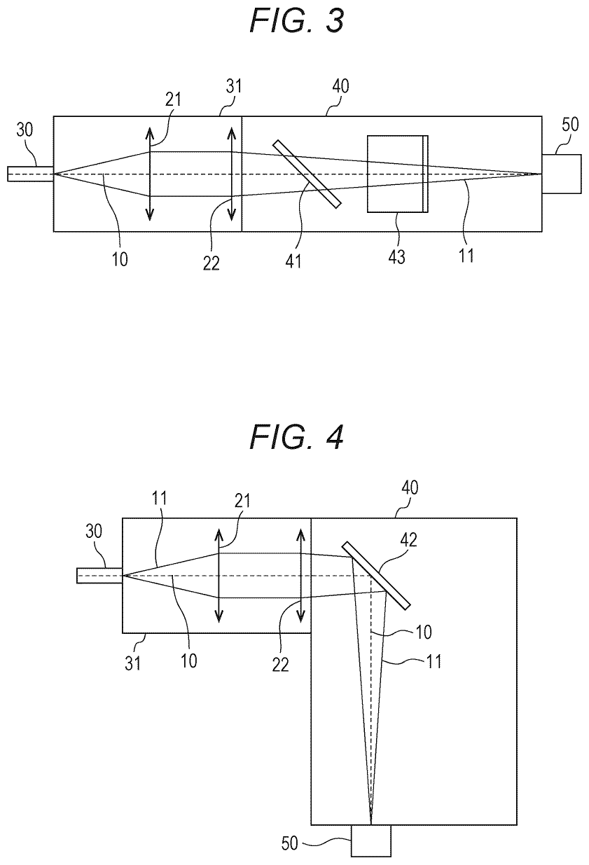

In another aspect of the first embodiment of the dimming device, two or more beam splitters according to the present invention may be used. For example, when two transmission type beam splitters are used, as illustrated in FIG. 3, the beam splitter 41 is disposed to be inclined at an angle α in a range of 30° or more and 60° or less with respect to the optical axis 10 with the X axis as the rotation axis, and a beam splitter 43 is disposed to be inclined at an angle α with respect to the optical axis 10 with the Y axis as the rotation axis. By disposing the two beam splitters in this manner, the image of the laser beam transmitted through the beam splitter 41 is distorted in the Y axis direction due to astigmatism, and the image of the laser beam transmitted through the beam splitter 43 is distorted in the X axis direction due to astigmatism. Therefore, the image observed by the observation device 50 has a similar shape to the image of the beam splitter incident on the dimming device 40. Therefore, it is possible to accurately observe the image shape and the energy intensity distribution of the laser beam at the spot without correcting the astigmatism.

As described above, the dimming device according to another aspect of the first embodiment can reduce the energy intensity of the laser beam to output the laser beam without deviating the energy intensity distribution of the emitted light with respect to the incident light, so that the energy intensity distribution of the laser beam at the spot can be accurately measured. Furthermore, by adopting the configuration using two transmission type beam splitters as described above, it is possible to accurately observe the image shape and the energy intensity distribution of the laser beam at the spot even if the image shape of the incident light is annular.

Note that the thickness of each of the beam splitter 41 and the beam splitter 43 is not particularly limited as long as it can be used for the dimming device.

Note that, in the configuration of the dimming device 40 illustrated in FIG. 1, in a case where light dimming is insufficient for a laser beam to have an energy intensity to be incident on the observation device 50, an optical element such as an ND filter capable of dimming the laser beam may be disposed between the beam splitter 41 and the observation device 50.

As described above, by adopting the first embodiment of the dimming device according to the present invention, the energy intensity of the laser beam can be reduced to output the laser beam from the dimming device. Then, the dimming device can reduce the energy intensity of the laser beam to output the laser beam from the dimming device without deviating the energy intensity distribution of the emitted light with respect to the incident light even if the incident light to the beam splitter 41 is collected light having an incident angle different depending on the incident position. Further, in the dimming device, the power of the laser beam that can be incident is usually as large as 1 kW. The dimming device can dim the laser beam to an extent that the observation device 50 that acquires image data such as an image sensor or a camera is not destroyed, even if the energy intensity of the laser beam is high to measure an image shape and an energy intensity distribution of the laser beam at the spot.

### Second Embodiment of Dimming Device

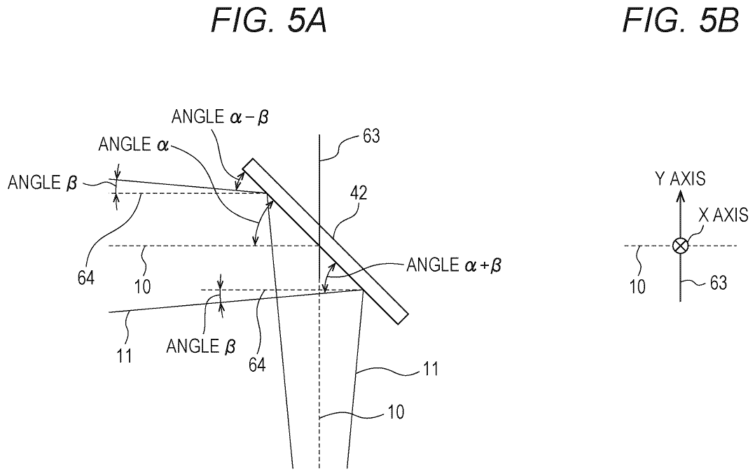

The second embodiment of a dimming device according to the present invention is a configuration of the dimming device 40 of the second embodiment of the dimming device illustrated in FIG. 4, and includes a plate-type beam splitter 42 closer to the spot (observation device 50) than the laser beam irradiation optical unit 31 and a cylindrical light guide unit that holds the beam splitter 42 and has an opening close to at least on the laser beam irradiation optical unit 31. The beam splitter 42 has an optical thin film of 10 or more layers formed close to a surface on which the laser beam incident side. When any orthogonal coordinate axes whose origin in a plane perpendicular to the optical axis 10 is on the optical axis 10 are defined as an X axis and a Y axis, the beam splitter 42 is disposed so as to be inclined at an angle α in a range of 30° or more and 60° or less with respect to the optical axis 10 with the X axis as a rotation axis. Note that as illustrated in FIG. 5B, the X axis is a straight line, on the plane, perpendicular to the optical axis 10 described above, perpendicularly penetrating the plane when the figure of FIG. 4 is taken as the plane with the optical axis 10 as an origin, and the Y axis is a straight line, on the plane, perpendicular to the optical axis 10 described above, and perpendicular to the X-axis on the plane when the figure of FIG. 4 is taken as the plane with the optical axis 10 as an origin. The directions of the arrows of the X axis and the Y axis may be opposite to the directions illustrated in FIG. 5B. The beam splitter 42 may be disposed in such a manner that the center position of the beam splitter 42 coincides with the optical axis 10, but may be disposed in such a manner that at least the laser beam radiation trajectory 11 is within the optically effective surface of the beam splitter 42. Although not illustrated in FIG. 4, the cylindrical light guide unit has a structure indicated by a frame line of dimming device 40.

The beam splitter 42 has a function of splitting an incident laser beam into transmitted light and reflected light. In FIG. 4, the laser beam radiation trajectory 11 indicates a trajectory of a laser beam incident on the beam splitter 43 and a trajectory of reflected light of the beam splitter 42, and transmitted light of the beam splitter 42 is not illustrated. Unnecessary transmitted light transmitted through the beam splitter 42 may radiated to a copper plate or the like processed to have a black surface so as to easily absorb the laser beam for absorptive radiation.

In FIG. 4, as indicated by the radiation trajectory 11, since a laser beam is incident on the beam splitter 42 via the condenser lens 22, the incident angle of the laser beam on the beam splitter 42 continuously changes in the Y axis direction described above. FIG. 5a illustrates an enlarged view of the beam splitter 42. The incident angle of the laser beam on the beam splitter 42 at the position of the optical axis 10 is an angle α. Here, the incident angle of the laser beam at the position of the upper end or the lower end of the radiation trajectory 11 with respect to the virtual line 64 parallel to the optical axis 10 is defined as an angle β. At this time, the incident angle of the laser beam on the beam splitter 42 at the position of the upper end of the radiation trajectory 11 is represented by α−β. Similarly, the incident angle of the laser beam on the beam splitter 42 at the position of the lower end of the radiation trajectory 11 is represented by α+β. That is, the incident angle of the laser beam on the beam splitter 42 changes in a range of α−β or more and α+β or less according to the incident position of the laser beam on the beam splitter 42. Here, the value of the angle β is not particularly limited, but the angle β is 5° or less in consideration of the optical design of the laser beam irradiation optical unit. Therefore, the incident angle of the laser beam on the beam splitter 42 is in the range of α−5° or more and α+5° or less.

Here, it is preferable that the reflectance of the beam splitter 42 when the incident angle of the laser beam on the beam splitter 42 is an angle α is 2.0% or less. This is because even when the reflected light of the beam splitter 42 is incident on the observation device 50 in order to measure the energy intensity distribution and the image shape of the laser beam, the observation device 50 can perform measurement without causing destruction or deterioration. In the specification of the present invention, the beam splitter 42 is referred to as a reflection type. Note that, since a necessary function of the beam splitter 42 is light reduction of an incident laser beam and is not light shielding, the reflectance of the beam splitter 42 at the angle α is preferably 0.001% or more.

The reflection type beam splitter 42 preferably satisfies following Conditional Expression (2). This is because, by satisfying the Conditional Expression, even when the incident angle of the laser beam on the beam splitter 42 changes in the range of α−5° or more and α+5° or less, the variation in the reflectance can be reduced, and the observation device 50 can measure the energy intensity distribution at the spot by the reflected light of the beam splitter 42 with high accuracy.

$$0 \leq ( R max - R min ) / Rave \leq 0.05 \qquad ( 2 )$$

where
Rmax is a maximum value of a reflectance of the beam splitter 42 when an incident angle of the laser beam on the reflection type beam splitter 42 is in a range of α−5° or more and α+5° or less,
Rmin is a minimum value of a reflectance of the beam splitter 42 when an incident angle of the laser beam on the reflection type beam splitter 42 is in a range of α−5° or more and α+5° or less, and
Rave is an average value of reflectances of the beam splitter 42 when an incident angle of the laser beam on the reflection type beam splitter 42 is in a range of α−5° or more and α+5° or less.

Here, in the second embodiment of the dimming device, since the reflected light is incident on the observation device 50 using the reflection type beam splitter 42 and measured, the astigmatism described in the first embodiment of the dimming device does not occur.

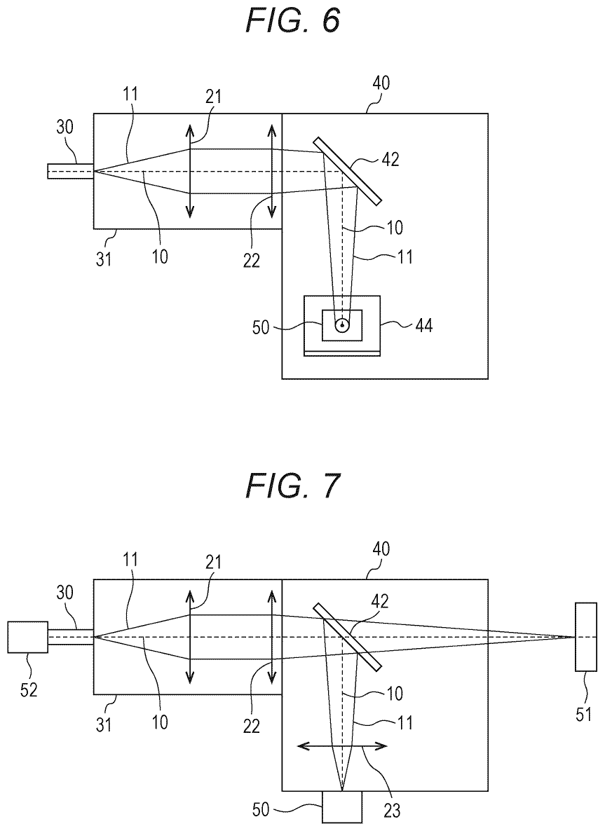

Further, in another aspect of the second embodiment of the dimming device, a configuration in which two or more beam splitters according to the present invention are used is also possible. For example, when two reflection type beam splitters are used, as illustrated in FIG. 6, the beam splitter 42 is disposed to be inclined at an angle α in a range of 30° or more and 60° or less with respect to the optical axis 10 with the X axis as the rotation axis, and a beam splitter 44 is disposed to be inclined at an angle α with respect to the optical axis 10 with the Y axis as the rotation axis. Note that, in FIG. 6, the laser beam reflected by the beam splitter 44 is emitted in a direction protruding forward from the plane when the figure of FIG. 6 is taken as a plane, and the observation device 50 is disposed at the focusing position of the reflected light of the beam splitter 44. By disposing the two beam splitters in this manner, the working distance can be shortened and the image shape and the energy intensity distribution of the laser beam at the spot can be accurately observed as compared with the configuration using two transmission type beam splitters.

As described above, since the dimming device according to another aspect of the second embodiment can reduce the energy intensity of the laser beam to output the laser beam without deviating the energy intensity distribution of the emitted light with respect to the incident light and without generating astigmatism, it is possible to accurately measure the image shape and the energy intensity distribution of the laser beam at the spot even if the image shape of the incident light is annular.

Note that the thickness of each of the beam splitter 42 and the beam splitter 44 is not particularly limited as long as it can be used for the dimming device.

Note that, in the configuration of the dimming device 40 illustrated in FIG. 4, in a case where light dimming is insufficient for a laser beam to have an energy intensity to be incident on the observation device 50, an optical element such as an ND filter capable of dimming the laser beam may be disposed between the beam splitter 42 and the observation device 50.

As described above, by adopting the second embodiment of the dimming device according to the present invention, the energy intensity of the laser beam can be reduced to output the laser beam from the dimming device. Then, the dimming device can reduce the energy intensity of the laser beam to output the laser beam from the dimming device without deviating the energy intensity distribution of the emitted light with respect to the incident light even if the incident light to the beam splitter 42 is collected light having an incident angle different depending on the incident position. Further, in the dimming device, the power of the laser beam that can be incident is usually as large as 1 kW. The dimming device can dim the laser beam to an extent that the observation device 50 that acquires image data such as an image sensor or a camera is not destroyed, even if the energy intensity of the laser beam is high to measure an image shape and an energy intensity distribution of the laser beam at the spot.

### [Collimator Lens]

The collimator lens 21 is an optical element for collimating a laser beam radially output from an output end of the optical fiber 30.

### [Condenser Lens]

The condenser lens 22 is an optical element for collecting and condensing the laser beam converted into collimated light by the collimator lens 21 at a spot.

### [Beam Splitter]

The beam splitters include cube-type beam splitters and plate-type beam splitters. It is preferable that the beam splitter according to the present invention is a plate-type beam splitter. The shape of the plate-type beam splitter is not particularly limited as long as it can be used for the dimming device according to the present invention, and may be a quadrangle, a polygon, or a circle. Further, the plate-type beam splitter may be a polarizing beam splitter or a non-polarizing beam splitter. The cube-type beam splitter is not preferable, because there is a plurality of planes perpendicular to an incidence direction of a laser beam, causing light returning to the laser oscillator (the light source) of a laser beam, and resulting in unstable oscillation of the laser. In addition, the cube-type beam splitter usually has a structure in which inclined faces of two prisms are joined to each other using a joining resin. The cube-type beam splitter has a larger volume than the plate-type beam splitter. Therefore, the cube-type beam splitter is not preferable, because, for example, the resin used for joining is easily denatured by heat generated when a laser beam is incident, the generated heat is difficult to dissipate and is easily damaged as compared with that in the plate-type beam splitter.

It is preferable that the beam splitter according to the present invention has an optical thin film of 10 or more layers is formed close to a surface on which the laser beam is incident. By forming the optical thin film of 10 or more layers on the surface of the beam splitter, even when the incident angle of the laser beam on the beam splitter changes in the range of α−5° or more and α+5° or less, the variation in the transmittance or the reflectance can be reduced, that is, Conditional Expression (1) or Conditional Expression (2) can be satisfied. As a result, even when the transmitted light of the beam splitter 41 or the reflected light of the beam splitter 42 is a laser beam obtained by dimming the incident laser beam and the incident laser beam is collected light, the energy intensity distribution at the spot can be measured with high accuracy by observing the transmitted light of the beam splitter 41 or the reflected light of the beam splitter 42 by the observation device 50.

The number of stacked layers of the optical thin film formed on the beam splitter is more preferably 15 or more, still more preferably 19 or more. This is because the variation in transmittance or reflectance can be further reduced.

### [Observation Device]

The observation device 50 is not particularly limited as long as it can observe an irradiation position and an image shape of a laser beam and an energy intensity distribution of the laser beam at the spot, and any observation device such as an image sensor, for example, a CCD or a CMOS, can be used. Then, it is preferable that the observation device 50 can output an observation result as data. This is because a numerical calculation can be performed on the data output from the observation device 50 using the arithmetic device. In addition, it is preferable that the dimming device 40 to which the observation device 50 is connected is detachable from the laser beam irradiation optical unit 31. It is preferable that the position of an image plane (observation point) of the observation device 50 when the dimming device 40 is connected to the laser beam irradiation optical unit 31 is located at the same place as a surface of an object to be machining processed on which a spot is to be formed during laser machining. Furthermore, it is preferable that the center of the image plane of the observation device 50 is located on the optical axis 10 and at the center of the machining processed portion of the object to be machining processed. This is because the position of the laser beam and the energy distribution of the laser beam can be observed at the same position as the surface of the object to be machining processed on which a spot is to be formed.

### 2. Embodiment of Laser Machining Device

In the embodiment of the dimming device according to the present invention, the configuration in which the dimming device 40 is detachable from the laser beam irradiation optical unit 31 is described as an example. That is, the dimming device 40 is attached to the laser beam irradiation optical unit 31, the observation device 50 measures the irradiation position, the image shape, and the energy intensity distribution of the laser beam emitted from the laser beam irradiation optical unit 31, and when necessary, the image shape of the laser beam and the energy intensity distribution of the laser beam at the spot are adjusted and measured again. Thereafter, the dimming device 40 is removed from the laser beam irradiation optical unit 31, and the laser machining is performed by the laser machining device including the laser beam irradiation optical unit 31. However, the laser machining device according to the present invention is not limited thereto, and for example, laser machining can be performed by a laser machining device in which the dimming device 40 is still attached to the laser beam irradiation optical unit 31.

Such a laser machining device is illustrated in FIG. 7. FIG. 7 illustrates a configuration in which the second embodiment of the dimming device is used as the dimming device 40. In the laser machining device, the optical fiber 30 that guides and emits a laser beam output from a laser oscillator 52, the collimator lens 21 that collimates the laser beam output in a diffused manner from an output end of the optical fiber 30, the condenser lens 22 that collects and condenses the laser beam collimated by the collimator lens 21 at a spot on a surface of an object to be machining processed 51, the dimming device 40 that dims the laser beam collected and condensed at a spot by the condenser lens 22, and the observation device 50 that observes observation light for checking an image shape and an intensity distribution of the laser beam at the spot are disposed in order from the laser oscillator side along the optical axis 10 of the radiation trajectory 11 of the laser beam irradiation optical unit 31. In FIG. 7, since the reflection type beam splitter 42 is used, reflected light of the beam splitter 42 is observed by the observation device 50. Note that, here, by further providing a condenser lens 23 between the beam splitter 42 and the observation device 50, a point at which the reflected light of the beam splitter 42 converges is closer to the beam splitter 42. Then, by performing laser machining on an object to be machining processed 51 using the transmitted light of the beam splitter 42, laser machining can be performed while observing the laser beam with the observation device 50.

Although described with reference to FIG. 7, the laser machining device according to the present invention may employ the first embodiment of the dimming device as the dimming device 40. Although similarly understood from the above description, in this case, since the transmission type beam splitter 41 is used, it is possible to perform laser machining on the object to be machining processed 51 using the reflected light of the beam splitter 41 while observing the transmitted light of the beam splitter by the observation device 50.

With such a configuration of the laser machining device, it is possible to perform laser machining on the object to be machining processed 51 while observing the image shape and the energy intensity distribution of the laser beam at the spot by the observation device 50. Note that, here, the configuration is described in which the laser machining is performed in a state where the dimming device 40 detachable from the laser beam irradiation optical unit 31 is attached, but, in the present invention, the dimming device 40 may be integrated with the laser beam irradiation optical unit 31, that is, the dimming device 40 may be configured to be undetachable from the laser beam irradiation optical unit 31. Even in this case, it is possible to perform laser machining on the object to be machining processed 51 while observing the image shape and the energy intensity distribution of the laser beam at the spot by the observation device 50.

### 3. Embodiment of Laser Beam Measurement Device

A laser beam measurement device according to the present invention is a device for checking an image shape of a laser beam at the spot and an energy intensity distribution of the image shape, and includes the dimming device 40 according to any one of the first embodiment of the dimming device to the second embodiment of the dimming device described above. The laser beam measurement device preferably includes the observation device 50 and the arithmetic device described above. By this, even if the energy intensity of the laser beam incident on the dimming device 40 is high, the laser beam can be dimmed to an extent that the observation device 50 that acquires image data such as an image sensor or camera is not destroyed to accurately measure the image shape and energy intensity distribution of the laser beam at the spot. In addition, the image shape and the energy intensity distribution of the laser beam at the spot can be visually checked, and the image shape observed distorted in the Y axis direction due to astigmatism can be corrected by outputting as data.

The embodiment of the present invention described above is an aspect of the present invention, and can be appropriately modified without departing from the gist of the present invention. In addition, the dimming device of the present invention will be more specifically described below using the following Examples, but the present invention is not limited to the following Examples.

### Example 1

In the first embodiment of the dimming device, as the optical thin film formed on the surface of the beam splitter 41, an optical thin film having a multilayer structure in which Ta₂O₅ is used as the optical material of the high refractive index layer, SiO₂ is used as the optical material of the low refractive index layer, and the high refractive index layer and the low refractive index layer are alternately stacked is used. Then, the optical thin film was designed with the angle α set to 450 and the target value of transmittance at the angle α set to 0.2% or less, 0.5% or less, or 1.0% or less, and the beam splitter 41 on which the optical thin film was formed was prepared. Then, the wavelength of the incident laser beam is set to 1070 nm, the transmittance of the beam splitter 41 when the incident angle of the laser beam on the beam splitter 41 is in a range of α−5° or more and α+5° or less is measured, and a result of calculating a value of “(Tmax−Tmin)/Tave” in Conditional Expression (1) is shown in Table 1. The “name” in Table 1 indicates a name of the performed optical thin film, and the “total film thickness” is a total film thickness of the optical thin films stacked in the multilayer structure.

TABLE 1

| | | Optical | The number | | | | | |
|---|---|---|---|---|---|---|---|---|
| | Target | material of | of layers of | Total film | | | | |
| | value of | optical thin | optical thin | thickness | | | | (Tmax − |
| Name | transmittance | film | film | (μm) | Tmax(%) | Tmin(%) | Tave(%) | Tmin)/Tave |
| T1 | 0.2% | Ta₂O₅ | 52 | 10.50 | 0.1503 | 0.1488 | 0.1497 | 0.010 |
| T2 | 0.5% | SiO₂ | 31 | 5.82 | 0.4612 | 0.4394 | 0.4468 | 0.049 |
| T3 | | | 52 | 9.53 | 0.4500 | 0.4471 | 0.4490 | 0.006 |
| T4 | 1.0% | | 33 | 5.85 | 0.9630 | 0.9291 | 0.9463 | 0.036 |
| T5 | | | 52 | 8.79 | 0.9503 | 0.9425 | 0.9467 | 0.008 |

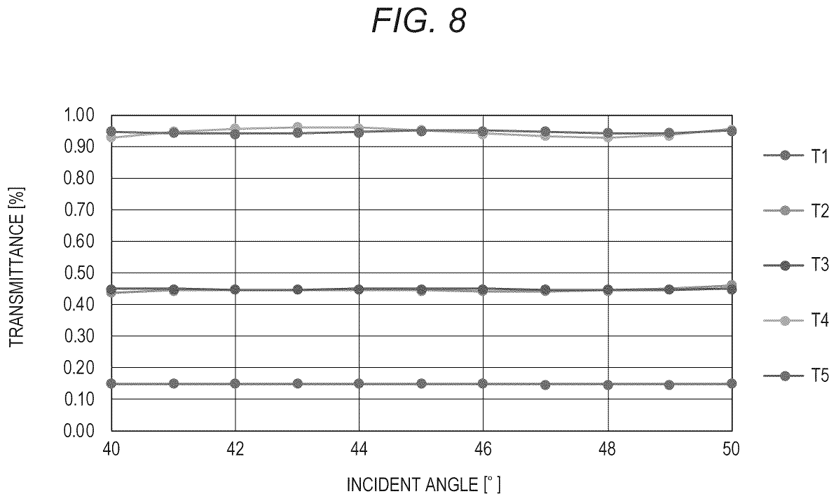

In addition, the transmittance with respect to the incident angle of the laser beam on the beam splitter 41 of Example 1 is illustrated in FIG. 8. A graph with a transmittance of around 0.15% is T1, graphs with a transmittance of around 0.45% are T2 and T3, and graphs with a transmittance of around 0.95% are T4 and T5.

From Table 1 and FIG. 8, it has become clear that by adopting a beam splitter that has an optical thin film of 10 or more layers formed close to a surface on which the laser beam is incident, the transmittance of the beam splitter when the incident angle of the laser beam on the beam splitter 41 is an angle α is 2.0% or less, and Conditional Expression (1) is satisfied. In addition, it has become clear that the beam splitter using the optical thin film having a larger number of stacked layers tends to suppress the value of “(Tmax−Tmin)/Tave” in Conditional Expression (1) to a smaller value. That is, in Example 1, it has been found that even when the incident laser beam is dimmed to 2.0% or less, and the incident angle of the laser beam on the beam splitter 41 changes in the range of α−5° or more and α+5° or less, the variation in transmittance can be reduced. Therefore, in Example 1, even when the incident laser beam is collected light, the energy intensity distribution at the spot can be measured with high accuracy by observing the transmitted light of Example 1 by the observation device 50.

### Example 2

In the second embodiment of the dimming device, as the optical thin film formed on the surface of the beam splitter 42, an optical thin film having a multilayer structure in which Ta₂O₅ is used as the optical material of the high refractive index layer, SiO₂ is used as the optical material of the low refractive index layer, and the high refractive index layer and the low refractive index layer are alternately stacked, or an optical thin film having a multilayer structure in which Nb₂O₅ is used as the optical material of the high refractive index layer, SiO₂ is used as the optical material of the low refractive index layer, and the high refractive index layer and the low refractive index layer are alternately stacked is used. Then, the optical thin film was designed with the angle α set to 45° and the target value of the reflectance at the angle α set to 0.2% or less, 0.5% or less, or 1.0% or less, and the beam splitter 42 on which the optical thin film was formed was prepared. Then, the wavelength of the incident laser beam is set to 1070 nm, the reflectance of the beam splitter 42 when the incident angle of the laser beam on the beam splitter 42 is in a range of α−5° or more and α+5° or less is measured, and a result of calculating a value of “(Rmax−Rmin)/Rave” in Conditional Expression (2) is shown in Table 2. The “name” in Table 2 indicates the name of the performed optical thin film, and the “total film thickness” is the total film thickness of the optical thin films stacked in the multilayer structure.

TABLE 2

| | | Optical | The number | | | | | |
|---|---|---|---|---|---|---|---|---|
| | Target | material of | of layers of | Total film | | | | |
| | value of | optical thin | optical thin | thickness | Rmax | Rmin | Rave | (Rmax − |
| Name | reflectance | film | film | (μm) | (%) | (%) | (%) | Rmin)/Rave |
| R1 | 0.2% | Ta₂O₅ | 50 | 12.4 | 0.1500 | 0.1457 | 0.1482 | 0.029 |
| R2 | 0.5% | SiO₂ | 20 | 2.4 | 0.4524 | 0.4386 | 0.4464 | 0.031 |
| R3 | | | 31 | 4.5 | 0.4511 | 0.4467 | 0.4494 | 0.010 |
| R4 | | | 51 | 8.1 | 0.4502 | 0.4449 | 0.4483 | 0.012 |
| R5 | 1.0% | | 20 | 2.6 | 0.9520 | 0.9411 | 0.9473 | 0.011 |
| R6 | | | 30 | 5.0 | 0.9511 | 0.9454 | 0.9490 | 0.006 |
| R7 | | | 51 | 8.1 | 0.9511 | 0.9442 | 0.9484 | 0.007 |
| R8 | 0.2% | Nb₂O₅ | 19 | 2.6 | 0.1501 | 0.1436 | 0.1472 | 0.044 |
| R9 | | SiO₂ | 31 | 4.2 | 0.1506 | 0.1440 | 0.1484 | 0.045 |
| R10 | | | 50 | 12.2 | 0.1506 | 0.1471 | 0.1489 | 0.024 |
| R11 | 0.5% | | 19 | 3.0 | 0.4502 | 0.4419 | 0.4475 | 0.018 |
| R12 | | | 31 | 4.2 | 0.4529 | 0.4458 | 0.4497 | 0.016 |
| R13 | | | 51 | 8.8 | 0.4515 | 0.4469 | 0.4496 | 0.010 |
| R14 | 1.0% | | 19 | 3.3 | 0.9517 | 0.9408 | 0.9480 | 0.011 |
| R15 | | | 31 | 4.6 | 0.9505 | 0.9463 | 0.9490 | 0.004 |
| R16 | | | 51 | 8.2 | 0.9500 | 0.9420 | 0.9473 | 0.008 |

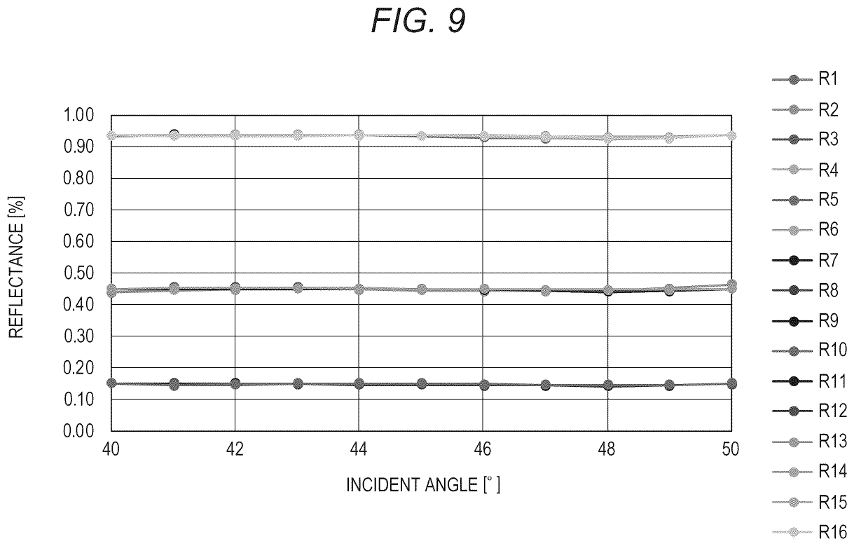

In addition, FIG. 9 illustrates the reflectance with respect to the incident angle of the laser beam on the beam splitter 42 of Example 2. Graphs with a reflectance of around 0.15% is R1 or R8-R10, graphs with a reflectance of around 0.45% is R2-R4 or R11-R13, and graphs with a reflectance of around 0.95% is R5-R7 or R14-R16.

From Table 2 and FIG. 9, it has become clear that by adopting a beam splitter that has an optical thin film of 10 or more layers formed close to a surface on which the laser beam is incident, the reflectance of the beam splitter when the incident angle of the laser beam on the beam splitter 42 is an angle α is 2.0% or less, and Conditional Expression (2) is satisfied. In addition, it has become clear that the beam splitter using the optical thin film having a larger number of stacked layers tends to suppress the value of “(Rmax−Rmin)/Rave” in Conditional Expression (2) to a smaller value. That is, in Example 2, it has become clear that, even when the incident laser beam is dimmed to 2.0% or less, and the incident angle of the laser beam on the beam splitter 42 changes in the range of α−5° or more and α+5° or less, the variation in reflectance can be reduced. Therefore, in Example 2, even when the incident laser beam is collected light, the energy intensity distribution at the spot can be measured with high accuracy by observing the reflected light of Example 2 by the observation device 50.

The dimming device for reducing the laser beam radiated from the laser beam irradiation optical unit according to the present invention can dim the laser beam using the beam splitter to an extent that the device that acquires image data such as an image sensor and a camera is not destroyed even when the energy intensity of the incident laser beam is high, and can accurately measure the image shape and the energy intensity distribution of the laser beam at the spot even if the laser beam is collected light. In other words, the dimming device that dims the laser beam radiated from the laser beam irradiation optical unit is suitable when in a laser machining device that performs machining processing on an object to be machining processed by radiating a laser beam, the image shape of the laser beam at the spot and the energy intensity distribution of the laser beam are measured using an observation device.

What is claimed is:

1. A dimming device that dims a laser beam radiated from a laser beam irradiation optical unit that irradiates an object to be machining processed with the laser beam collected and condensed, a spot being formed at the object to be machining processed, to perform laser machining, the dimming device comprising:
a beam splitter that has an optical thin film of 10 or more layers formed close to a surface on which the laser beam is incident, and that, when any orthogonal coordinate axes whose origin in a plane perpendicular to an optical axis of the laser beam irradiation optical unit is on the optical axis are defined as an X axis and a Y axis, is disposed so as to be inclined at an angle α of 30° or more and 60° or less with respect to the optical axis with the X axis as a rotation axis.

2. The dimming device according to claim 1, further comprising a cylindrical light guide unit that holds the beam splitter and has an opening close to at least the laser beam irradiation optical unit.

3. The dimming device according to claim 1, wherein
the beam splitter includes
a transmission type in which a transmittance of the beam splitter when an incident angle of the laser beam on the beam splitter is the angle α is 2.0% or less and that satisfies following Conditional Expression (1): or
a reflection type in which a reflectance of the beam splitter when an incident angle of the laser beam on the beam splitter is the angle α is 2.0% or less and that satisfies following Conditional Expression (2):
$$0 \leq ( T max - T min ) / Tave \leq 0.05 \qquad ( 1 )$$
$$0 \leq ( R max - R min ) / Rave \leq 0.05 \qquad ( 2 )$$
where
Tmax is a maximum value of a transmittance of the beam splitter when an incident angle of a laser beam on the transmission type beam splitter is in a range of α−5° or more and α+5° or less,
Tmin is a minimum value of a transmittance of the beam splitter when an incident angle of a laser beam on the transmission type beam splitter is in a range of α−5° or more and α+5° or less,
Tave is an average value of transmittances of the beam splitter when an incident angle of a laser beam on the transmission type beam splitter is in a range of α−5° or more and α+5° or less,
Rmax is a maximum value of a reflectance of the beam splitter when an incident angle of a laser beam on the reflection type beam splitter is in a range of α−5° or more and α+5° or less,
Rmin is a minimum value of the reflectance of the beam splitter when an incident angle of a laser beam on the reflection type beam splitter is in a range of α−5° or more and α+5° or less, and
Rave is an average value of reflectances of the beam splitter when an incident angle of a laser beam on the reflection type beam splitter is in a range of α−5° or more and α+5° or less.

4. A laser machining device comprising:
a laser beam irradiation optical unit configured to irradiate an object to be machining processed with a laser beam collected and condensed, a spot being formed at the object to be machining processed, to perform laser machining; and
a dimming device configured to dim the laser beam radiated from the laser beam irradiation optical unit by using a beam splitter that has an optical thin film of 10 or more layers formed close to a surface on which the laser beam is incident, and that, when any orthogonal coordinate axes whose origin in a plane perpendicular to an optical axis of the laser beam irradiation optical unit is on the optical axis are defined as an X axis and a Y axis, is disposed so as to be inclined at an angle α of 30° or more and 60° or less with respect to the optical axis with the X axis as a rotation axis.

5. The laser machining device according to claim 4, wherein
the beam splitter includes
a transmission type in which a transmittance of the beam splitter when an incident angle of the laser beam on the beam splitter is the angle α is 2.0% or less and that satisfies following Conditional Expression (1): or
a reflection type in which a reflectance of the beam splitter when an incident angle of the laser beam on the beam splitter is the angle α is 2.0% or less and that satisfies following Conditional Expression (2):
$$0 \leq ( T max - T min ) / Tave \leq 0.05 \qquad ( 1 )$$
$$0 \leq ( R max - R min ) / Rave \leq 0.05 \qquad ( 2 )$$
where
Tmax is a maximum value of a transmittance of the beam splitter when an incident angle of a laser beam on the transmission type beam splitter is in a range of α−5° or more and α+5° or less,
Tmin is a minimum value of a transmittance of the beam splitter when an incident angle of a laser beam on the transmission type beam splitter is in a range of α−5° or more and α+5° or less,
Tave is an average value of transmittances of the beam splitter when an incident angle of a laser beam on the transmission type beam splitter is in a range of α−5° or more and α+5° or less,
Rmax is a maximum value of a reflectance of the beam splitter when an incident angle of a laser beam on the reflection type beam splitter is in a range of α−5° or more and α+5° or less,
Rmin is a minimum value of the reflectance of the beam splitter when an incident angle of a laser beam on the reflection type beam splitter is in a range of α−5° or more and α+5° or less, and
Rave is an average value of reflectances of the beam splitter when an incident angle of a laser beam on the reflection type beam splitter is in a range of α−5° or more and α+5° or less.

6. A laser beam measurement device comprising: the dimming device according to claim 1; and an observation device configured to observe a laser beam dimmed by the dimming device.
